(19) United States
(12) Patent Application Publication
(10) Pub. No.: US 2006/0177665 A1
(43) Pub. Date: Aug. 10, 2006

(54) Arrangement of at least one heat-insulation layer on a carrier body

(75) Inventors: Ulrich Bast, Munich (DE); Wolfgang Rossner, Holzkirchen (DE)

Correspondence Address: YOUNG & THOMPSON, 745 SOUTH 23RD STREET, 2ND FLOOR, ARLINGTON, VA, 22202, US

(73) Assignee: SIEMENS AKTIENGESELLSCHAFT, MUNCHEN (DE)

(21) Appl. No.: 10/564,413

(22) PCT Filed: Jul. 28, 2004
(86) PCT No.: PCT/EP04/51633

§ 371 Date: Jan. 12, 2006

(30) Foreign Application Priority Data
Aug. 13, 2003 (DE) 10337288.1

(51) Int. Cl. B32B 9/04

(52) U.S. Cl. 428/411.1; 428/702; 428/690

(57) ABSTRACT

An arrangement of at least one heat-insulation layer for a carrier body for preventing heat transfer between the body and a surrounding area includes at least one type of luminous substance which is excitable by an excitation light having a determined excitation wavelength for emitting a luminescent light having a defined emission wavelength and at least a second heat-insulation layer substantially free of the luminous substance. The second heat-insulation layer is opaque with respect to the excitation light used for initiating the luminescent light emission and/or to a luminous substance light. The luminous substance contains at least one type of mixed oxide selected from a perovskite group of total formula AA′O₃, and/or of pyrochlore of total formula A₂B₂O₇, wherein A and A′ is the trivalent metal, respectively and B is a tetravalent metal.

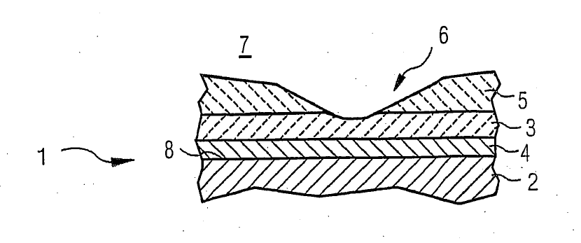

The invention relates to an arrangement of at least one heat-insulation layer on a carrier body for preventing heat transfer between the carrier body and a surrounding area of the carrier body, where the heat-insulation layer displays at least one luminescent substance which can be excited with the aid of excitation light having a specific excitation wavelength to emit a luminescent light having a specific luminescence wavelength, and where at least one further heat-insulation layer is present which is essentially free of the luminescent substance.

An arrangement of this type is known from EP 1 105 550 B1. The carrier body comprises a component of a gas turbine. The carrier body is made of a metal. A high temperature arising in a gas turbine of more than 1200° C. in the surrounding area of the component may result in damage to the metal of the component. To prevent this, a heat-insulation layer (Thermal Barrier Coating, TBC) is applied to the component. The heat-insulation layer makes sure that a reduced heat exchange takes place between the carrier body made of the metal and the surrounding area. As a result, a metal surface of the component heats up less strongly. A surface temperature occurs at the metal surface of the component that is lower than the temperature in the surrounding area of the component.

The heat insulation substance forms a basic material of the heat-insulation layer. The mechanical and thermal properties of the heat-insulation layer are essentially dependent on the properties of the heat insulation substance. The basic material of the known heat-insulation layer is a metal oxide. The metal oxide comprises a zirconium oxide stabilized with yttrium (YSZ), for example. The thermal conductivity of this heat-insulation substance constitutes between 1 W/m·K and 3 W/m·K. To ensure efficient protection of the carrier body, a layer thickness of the heat-insulation layer constitutes around 250 μm. As an alternative to zirconium oxide stabilized with yttrium, a metal oxide in the form of an yttrium-aluminum garnet is specified as a heat-insulation substance.

To firmly attach the heat-insulation layer and the carrier body, a metallic intermediate layer (Bond Coat) made of a metal alloy is applied to the surface of the component. For the purposes of improving the attachment, a ceramic intermediate layer made of a ceramic material, aluminum oxide for example, may additionally be arranged between the heat-insulation layer and the component.

A so-called thermo-luminescent indicator is embedded in the heat-insulation layer. This indicator comprises a luminescent substance (luminophore) which can be excited by means of excitation with excitation light of a specific excitation wavelength to emit a luminescent light having a specific emission wavelength. The excitation light comprises UV light, for example. The emission light comprises visible light, for example. The luminescent substance used comprises a so-called recombination luminescent substance. The luminescence process is produced by means of electronic transitions between energy states of the activator. A luminescent substance of this type consists, for example, of a solid with a crystal lattice (host crystal lattice) in which a so-called activator is embedded. The solid is doped with the activator. The activator takes part in the luminescence process of the luminescent substance together with the entire solid.

In the case of the known heat-insulation layer, the respective basic material of the heat-insulation layer is doped with an activator. A heat-insulation layer made of the luminescent substance is present.

The activator used in this respect is a rare earth element in each case. In the case of the zirconium oxide stabilized with yttrium, the rare earth element comprises europium, for example. The heat-insulation substance yttrium-aluminum garnet is doped with the rare earth elements dysprosium or terbium.

In the case of the known heat-insulation layer, use is made of the fact that an emission property of the luminescent light of the luminescent substance, an emission intensity or an emission decay time for example, is dependent on the temperature of the luminescent substance. The temperature of the heat-insulation layer with the luminescent substance is deduced on the basis of this dependency. In order that this relationship can be established, the heat-insulation layer is optically accessible for the excitation light in the UV range. At the same time, it is ensured that the luminescent light of the luminescent substance can be radiated by the heat-insulation layer and detected.

To ensure optical accessibility, only a single heat-insulation layer with the luminescent substance is arranged on the carrier body, for example. As an alternative solution to this, a further heat-insulation layer is applied to the heat-insulation layer, which is transparent for the excitation light and the luminescent light of the luminescent substance. The luminescent light of the luminescent substance can pass through the further heat-insulation layer.

To check the condition of the heat-insulation layer, a relatively complicated setup is necessary for exciting the luminescent substance and detecting the luminescent light of the luminescent substance.

The object of the present invention is therefore to specify an arrangement with a heat-insulation layer with luminescent heat-insulation substance which allows a simple determination of a condition of the heat-insulation layer on a carrier body.

For the purposes of achieving the object, an arrangement of at least one heat-insulation layer on a carrier body for preventing heat transfer between the carrier body and a surrounding area of the carrier body is specified, where the heat-insulation layer displays at least one luminescent substance which can be excited with the aid of excitation light having a specific excitation wavelength to emit a luminescent light having a specific luminescence wavelength, and where at least one further heat-insulation layer is present which is essentially free of the luminescent substance. The arrangement is characterized in that the further heat-insulation layer is essentially opaque with respect to the excitation light for exciting the emission of luminescent light and/or with respect to the luminescent light of the luminescent substance.

In this respect, the heat-insulation layer with the luminescent substance may be present in single-phase or multi-phase form. ‘Single-phase’ means that a ceramic phase, formed of the heat-insulation substance, of the heat-insulation layer consists essentially only of the luminescent substance. The heat-insulation substance of the heat-insulation layer comprises the luminescent substance. In the case of a multi-phase heat-insulation layer, the heat-insulation substance and the luminescent substance are different. The heat-insulation substance contains luminescent particles of the luminescent substance. The ceramic phase is formed of different materials. The luminescent particles are preferably distributed homogeneously over the heat-insulation layer. Furthermore, it is advantageous if the heat-insulation substance and the luminescent substance consist of a solid of essentially the same type. The two substances differ only by means of their optical properties. To this effect, the luminescent substance is doped, for example.

‘Opaque’ means in this case that the excitation light and/or the luminescent light is incapable or virtually incapable of passing through the further heat-insulation layer due to the transmission and/or absorption properties of the further heat-insulation layer. ‘Essentially’ means in this respect that a low permeability with respect to the excitation light and/or the luminescent light is provided under some circumstances.

In a special version, the heat-insulation layer is arranged between the carrier body and the further heat-insulation layer in such a way that the excitation light of the luminescent substance and/or the luminescent light of the luminescent substance can essentially only reach the surrounding area of the carrier body through apertures in the further heat-insulation layer. Apertures of this type comprise, for example, cracks or gaps in the further heat-insulation layer. It is also possible to conceive of an aperture which has been created by means of erosion (removal) of further heat-insulation substance of the further heat-insulation layer. These apertures can be made visible in a simple manner. Making them visible is effected by illuminating the arrangement with the excitation light. At the points where the UV light reaches the heat-insulation layer with the luminescent substance through the apertures, the luminescent substance is excited to emit the luminescent light. The luminescent light reaches the surrounding area of the carrier body again through the apertures and can be detected there. Due to the apertures, a luminescent light occurs which contrasts markedly with the background with regard to its intensity.

In the manner described, the heat-insulation layer of a carrier body used in a device can be checked in a simple and reliable manner during an interruption in the operation of the device. The device comprises a gas turbine, for example. The carrier body comprises a turbine vane of the gas turbine, for example. The multi-layer structure with the heat-insulation layers is located on the turbine vane. By illuminating the turbine vane and observing the luminescent light of the luminescent substance, those points on the further, outermost heat-insulation layer which display apertures become visible.

But it is also possible to conceive of a check on the condition of the heat-insulation layer being carried out during the operation of the device. To this effect, for example, a combustion chamber of the gas turbine described above, in which the turbine vanes are used, is equipped with a window through which the luminescence of the luminescent substance can be observed. The occurrence of luminescent light is an indication of the fact that the further, outermost heat-insulation layer of at least one turbine vane displays a crack or a gap and/or is eroded.

A further advantage of the arrangement described consists in the fact that as a consequence of advanced erosion, heat-insulation substance with the luminescent substance is also removed. The luminescent substance can be identified by means of corresponding detectors in the exhaust gas of the gas turbine. This is a sign of the fact that the erosion has progressed as far as the heat-insulation layer with the luminescent substance.

Any desired ceramic luminescent substance which can be used in a heat-insulation layer is conceivable as the luminescent substance. In a special version, the luminescent substance displays at least one metal oxide with at least one trivalent metal A. A luminescent substance of this type comprises, for example, a zirconium oxide stabilized or partially stabilized with yttrium and doped with an activator. Luminescent substances in the form of perovskites and pyrochlores are also conceivable in particular.

The said luminescent substances comprise so-called recombination luminescent substances. The emission of the luminescent light is preferably based in this respect on the presence of an activator. The emission property of the luminescent substance, the emission wavelength and the emission intensity for example, can be varied relatively easily with the aid of an activator or several activators.

In a special version, the luminescent substance displays an activator selected from the cerium and/or europium and/or dysprosium and/or terbium group for exciting the emission of luminescent light. In general, rare earth elements can be incorporated into the crystal lattices of metal oxides such as perovskite and pyrochlore very well due to their ionic radii. Consequently, activators in the form of rare earth elements are generally suitable. The rare earth elements listed have proved themselves to be particularly good activators.

Where an activator is used, its proportion in the luminescent substance is selected in such a way that the thermal and mechanical properties of the metal oxide of the luminescent substance are virtually unaffected. The mechanical and thermal properties of the metal oxide are retained intact in spite of doping. In a special version, the activator is contained in the luminescent substance in a proportion of up to 10 mol %. Preferably, the proportion constitutes less than 2 mol %. For example, the proportion comprises 1 mol %. It has been shown that this low proportion of the activator is sufficient to obtain a useful emission intensity of the luminescent substance. The thermal and mechanical stability of a heat-insulation layer manufactured with the luminescent substance is retained intact in this respect.

In a special version, the metal oxide of the luminescent substance comprises a mixed oxide selected from the perovskite group with the empirical formula AA′O₃ and/or pyrochlore group with the empirical formula A₂B₂O₇, where A′ comprises a trivalent metal and B comprises a tetravalent metal. A heat-insulation layer made of a perovskite and/or a pyrochlore (pyrochlore phase) is characterized by a high stability in respect of temperatures of more than 1200° C. Consequently, the arrangement is suitable for new generations of gas turbine where an increased efficiency is to be obtained by increasing the operating temperature.

In a special version, the trivalent metal A and/or the trivalent metal A′ comprises a rare earth element Re. In particular, the trivalent metal A and/or the trivalent metal A′ comprises a rare earth element selected from the lanthanum and/or gadolinium and/or samarium group. Further rare earth elements are similarly conceivable. By using a perovskite and/or a pyrochlore with these rare earth elements, an activator in the form of a rare earth element can be incorporated into the crystal lattice of the perovskite or the pyrochlore very easily due to the similar ionic radii.

One of the trivalent metals A and A′ of the perovskite comprises a main group or subgroup element. The tetravalent metal B of the pyrochlore similarly comprises a main or subgroup element. In both cases, mixtures of different main and subgroup elements can be envisioned. The rare earth elements and the main or subgroup elements preferentially take up different positions in the perovskite or pyrochlore crystal lattice due to the different ionic radii. Aluminum has proved itself to be particularly advantageous as a trivalent main group element in this respect. Together with rare earth elements, aluminum forms a perovskite, for example, which results in a mechanically and thermally stable heat-insulation layer. In a special version, the perovskite therefore comprises a rare earth aluminate. The empirical formula is ReAlO₃, where Re stands for a rare earth element. The rare earth aluminate preferably comprises a gadolinium-lanthanum aluminate. The empirical formula is Gd_{0,25}La_{0,75}Al0₃, for example. As the tetravalent metal B of the pyrochlore, the subgroup elements hafnium and/or titanium and/or zirconium are used in particular. The pyrochlore is therefore preferably selected from the rare earth titanate and/or rare earth hafnate and/or rare earth zirconate group. In particular, the rare earth zirconate is selected from the gadolinium zirconate and/or samarium zirconate group. The preferred empirical formulas are Gd₂Zr₂O₇ and Sm₂Zr₂O₇. The rare earth hafnate preferably comprises lanthanum hafnate. The empirical formula is La₂Hf₂O₇.

The excitation of the luminescent substance to emit luminescent light is effected optically. In this respect, the luminescent substance is irradiated with excitation light of a specific excitation wavelength. By absorption of the excitation light, the luminescent substance is excited to emit luminescent light. The excitation light comprises UV light, for example, and the luminescent light lower-energy visible light.

The excitation of the luminescent substance with excitation light is suitable for the purposes of checking a condition of a heat-insulation layer with the luminescent substance, which is optically accessible for the excitation light and the luminescent light. To this effect, for example, only the heat-insulation layer with the luminescent substance is applied to the carrier body.

In a special version, the carrier body comprises a component of an internal combustion engine. The internal combustion engine comprises a diesel engine, for example. In a special version, the internal combustion engine comprises a gas turbine. In this respect, the carrier body may comprise a tile with which a combustion chamber of the gas turbine is lined. In particular, the carrier body comprises a turbine vane of the gas turbine. It is conceivable in this respect that the different carrier bodies are provided with heat-insulation layers with luminescent substances that emit different luminescent light. Thus, the component on which damage is present can be determined in a simple manner.

For the purposes of applying the heat-insulation layer and the further heat-insulation layer, any desired coating process can be carried out. In particular, the coating process comprises a plasma spraying process. The coating process may also comprise a vapor deposition process, for example PVD (Physical Vapor Deposition) or CVD (Chemical Vapor Deposition). Heat-insulation layers with layer thicknesses of 50 μm to 600 μm and more are applied with the aid of the said processes.

In the following, the invention is explained in detail on the basis of several exemplary embodiments and an associated figure. The figure is schematic and does not represent true-to-scale illustrations.

The figure shows an extract of a transverse cross-section of an arrangement of a heat-insulation layer made of a heat-insulation substance with a luminescent substance and a further heat-insulation layer with a further heat-insulation substance from the side.

The arrangement 1 consists of a carrier body 2 on which a heat-insulation layer 3 and a further heat-insulation layer 5 are arranged. The carrier body 2 comprises a turbine vane of a gas turbine. The turbine vane is made of a metal. In the combustion chamber of the gas turbine, which the surrounding area 7 of the carrier body 2 represents, temperatures of more than 1200° C. may occur during the operation of the gas turbine. The heat-insulation layer 3 is present to prevent overheating of the surface 8 of the carrier body 2. The heat-insulation layer 3 serves to prevent heat transfer between the carrier body 2 and the surrounding area 7 of the carrier body 2.

A multi-layer structure is present with the heat-insulation layer 3, a metallic intermediate layer 4 (Bond Coat) made of a metal alloy, and a further heat-insulation layer 5. The heat-insulation layer 3 with the luminescent substance is arranged between the further heat-insulation layer 5 and the carrier body 2. The further heat-insulation layer 5 is opaque with respect to the excitation light and/or the luminescent light of the luminescent substance. The luminescent light of the luminescent substance can only be detected in the surrounding area 7 of the carrier body 2 if the further heat-insulation layer 5 displays an aperture 6.

### EXAMPLE 1

The heat-insulation substance of the heat-insulation layer 3 comprises a metal oxide in the form of a rare earth aluminate with the empirical formula Gd_{0,25}La_{0,75}Al0₃. According to a first embodiment, the rare earth aluminate is mixed with 1 mol % Eu₂O₃. The rare earth aluminate displays the activator europium in a proportion of 1 mol %. Exciting the luminescent substance with UV light results in a red luminescent light with an emission maximum at around 610 nm. The excitation wavelength constitutes 254 nm, for example.

According to an alternative embodiment to this, the rare earth aluminate is doped with 1 mol % terbium. The result is a luminescent substance with green luminescent light with an emission wavelength at around 544 nm.

### EXAMPLE 2

The heat-insulation layer 3 consists of a pyrochlore. The pyrochlore comprises a gadolinium zirconate with the empirical formula Gd₂Zr₂O₇. For the purposes of manufacturing the luminescent substance, the pyrochlore is mixed with 1 mol % Eu₂O₃. The gadolinium zirconate displays the activator europium in a proportion of 1 mol %.

### EXAMPLE 3

The heat-insulation layer 3 consists of a zirconium oxide stabilized with yttrium. For the purposes of manufacturing the luminescent substance, the zirconium oxide stabilized with yttrium is mixed with 1 mol % Eu₂O₃. The zirconium oxide stabilized with yttrium displays the activator europium in a proportion of 1 mol %.

1-15. (canceled)

16. Arrangement of at least one heat-insulation layer (3) on a carrier body (2) for preventing heat transfer between the carrier body (2) and a surrounding area (7) of the carrier body (2), where
the heat-insulation layer (3) displays at least one luminescent substance which can be excited with the aid of excitation light having a specific excitation wavelength to emit a luminescent light having a specific luminescence wavelength, and where
at least one further heat-insulation layer (5) is present which is essentially free of the luminescent substance, characterized in that
the further heat-insulation layer (5) is essentially opaque with respect to the excitation light for exciting the emission of luminescent light and/or with respect to the luminescent light of the luminescent substance.

17. Arrangement according to claim 16, where the heat-insulation layer (3) is arranged between the carrier body (2) and the further heat-insulation layer (5) in such a way that the luminescent light of the luminescent substance can essentially only reach the surrounding area (7) of the carrier body (2) through apertures (6) in the further heat-insulation layer (5).

18. Arrangement according to claim 16, where the luminescent substance displays at least one metal oxide with at least one trivalent metal A.

19. Arrangement according to claim 16, where the luminescent substance displays an activator selected from the cerium and/or europium and/or dysprosium and/or terbium group for exciting the emission of the luminescent light.

20. Arrangement according to claim 19, where the activator is contained in the luminescent substance in a proportion of up to 10 mol %.

21. Arrangement according to claim 18, where the metal oxide comprises a mixed oxide selected from the perovskite group with the empirical formula AA′O₃ and/or pyrochlore group with the empirical formula A₂B₂O₇, where A′ comprises a trivalent metal and B comprises a tetravalent metal.

22. Arrangement according to claim 21, where the trivalent metal A and/or the trivalent metal A′ comprises a rare earth element Re.

23. Arrangement according to claim 22, where the trivalent metal A and/or the trivalent metal A′ comprises a rare earth element selected from the lanthanum and/or gadolinium and/or samarium group.

24. Arrangement according to claim 21, where the perovskite comprises a rare earth aluminate.

25. Arrangement according to claim 24, where the empirical formula of the rare earth aluminate comprises Gd_{0,25}La_{0,75}Al0₃.

26. Arrangement according to claim 21, where the pyrochlore is selected from the rare earth hafnate and/or rate earth titanate and/or rare earth zirconate group.

27. Arrangement according to claim 26, where the rare earth zirconate is selected from the gadolinium zirconate and/or samarium zirconate group.

28. Arrangement according to claim 26, where the rare earth hafnate comprises lanthanum hafnate.

29. Arrangement according to claim 16, where the carrier body comprises a component of an internal combustion engine.

30. Arrangement according to claim 29, where the internal combustion engine comprises a gas turbine.

31. Arrangement according to claim 17, where the luminescent substance displays at least one metal oxide with at least one trivalent metal A.

32. Arrangement according to claim 19, where the metal oxide comprises a mixed oxide selected from the perovskite group with the empirical formula AA′O₃ and/or pyrochlore group with the empirical formula A₂B₂O₇, where A′ comprises a trivalent metal and B comprises a tetravalent metal.

33. Arrangement according to claim 20, where the metal oxide comprises a mixed oxide selected from the perovskite group with the empirical formula AA′O₃ and/or pyrochlore group with the empirical formula A₂B₂O₇, where A′ comprises a trivalent metal and B comprises a tetravalent metal.
